(19) United States
(12) Patent Application Publication
(10) Pub. No.: US 2026/0127048 A1
(43) Pub. Date: May 7, 2026

(54) DETERMINATION OF MICROSERVICES FROM MONOLITHIC APPLICATIONS

(71) Applicant: SAP SE, Walldorf (DE)

(72) Inventor: Hui LI, Shanghai (CN)

(21) Appl. No.: 18/936,054

(22) Filed: Nov. 4, 2024

(51) Int. Cl. G06F 9/54

(52) U.S. Cl. CPC G06F 9/541

(57) ABSTRACT

Systems and methods include identification of a plurality of tables of a computer system, determination, based on queries issued by the computer system, of a value associated with each pair of tables of the plurality of tables, and determination of a plurality of primary groups of the plurality of tables based on the values, where no pairs of tables belonging to different primary groups are associated with values greater than a first threshold value. For each of the plurality of primary groups, edge weights between each table of the primary group are determined based on the determined values, and the tables of the primary group are divided into one or more secondary groups of tables based on the determined edge weights. The computer system may be realigned based on the secondary groups of tables.

### BACKGROUND

Software applications are conventionally “monolithic”, in that their logic is contained within a single logical executable. To make any changes to such an application, a developer must build and deploy an updated version of the entire application. A monolithic application may be executed by a user device or by a server which serves the monolithic application to one or more user devices.

Monolithic applications have been increasingly migrated to the cloud in order to take advantage of the resource elasticity, redundancy, economies of scale and other benefits provided thereby. For example, all monolithic applications executing in a cloud environment share the computing resources (e.g., CPU, memory, and network bandwidth) of the cloud environment. Monolithic applications migrated to the cloud may expose their functionality in the form of Web services.

A microservice provides a discrete set of functions accessible via remote calls. A microservice is executed within a dedicated computing process and can be accessed independently from other microservices. A microservices-based application consists of respective independently-deployed microservices. Each microservice of a microservices-based application may be modified and redeployed independently without redeploying all microservices of the application. Due to the compatibility of a microservices architecture with a cloud environment, it is desirable to convert monolithic applications into applications which are composed of several microservices (i.e., a microservices-based application).

A typical monolithic application is data-intensive and relies on many database tables. When converting such a monolithic application to a microservices-based application, it is preferable to provide each microservice with its own database, where each database table of the application is stored in the database of only one microservice. If a first microservice needs to query or edit a database table of a second microservice, the first microservice initiates a remote call (e.g., HTTP, gRPC) to the second microservice. Accordingly, if the database tables are not efficiently apportioned among the microservices, operation of the microservices-based application will include large numbers of remote calls, reducing the inherent benefits of a microservices-based architecture.

Systems providing improved apportionment of database tables within a computer system are desired. Improved apportionment can reduce cross-microservice traffic and improve operation of the computer system. Improvements to apportionment are particularly useful when refactoring a monolithic application into microservices. Refactoring can be quite difficult and time consuming because relationships between the database tables of the microservices are often complex and cannot be gleaned manually. Modifications to deployed microservices may also require re-apportionment of their database tables to avoid increased cross-microservice traffic.

### BRIEF DESCRIPTION OF THE DRAWINGS

FIG. 1 illustrates a system to determine groups of database tables of a monolithic application for association with respective microservices according to some embodiments.

FIG. 2 is a flow diagram of a process to determine groups of database tables of a monolithic application for association with respective microservices according to some embodiments.

FIG. 3 is a tabular representation of counts of queries associated with table relationships according to some embodiments.

FIG. 4 is a graph of database tables according to some embodiments.

FIG. 5 shows groups of database tables according to some embodiments.

FIG. 6 shows primary and secondary groups of database tables according to some embodiments.

FIG. 7 is an undirected graph of database tables according to some embodiments.

FIG. 8 is an undirected weighted graph of database tables according to some embodiments.

FIG. 9 is a minimum spanning tree of database tables according to some embodiments.

FIG. 10 shows disconnected trees of database tables according to some embodiments.

FIG. 11 shows groups of database tables according to some embodiments.

FIG. 12 is a view of an interface to display and modify table groupings according to some embodiments.

FIG. 13 depicts reallocation of database tables according to some embodiments.

FIG. 14 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate logical grouping of tables of a monolithic application. A respective microservice may be developed for each group of tables in order to refactor the monolithic application into a microservices-based application. Due to the formation of the groups as described herein, the microservices-based application may execute more efficiently than otherwise.

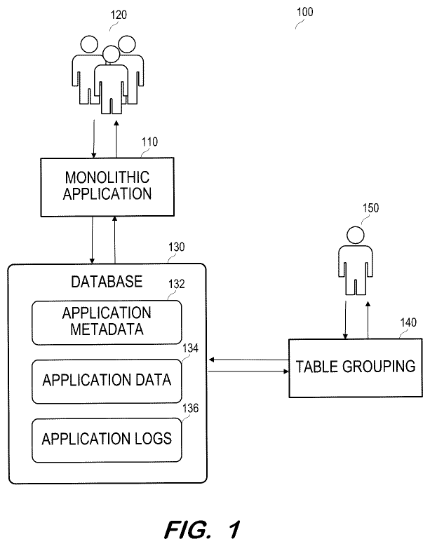

FIG. 1 illustrates system 100 according to some embodiments. The illustrated components of system 100 may be implemented using any suitable combinations of computing hardware and/or software that are or become known. In some embodiments, two or more components are implemented by a single computing device.

The components of system 100 may be on-premise, cloud-based (e.g., in which computing resources are virtualized and allocated elastically), distributed (e.g., with distributed storage and/or compute nodes) and/or deployed in any other suitable manner. Each component may comprise disparate cloud-based services, a single computer server, a cluster of servers, and any other combination that is or becomes known. All or a part of each system may utilize Infrastructure-as-a-Service (IaaS), Platform-as-a-Service (PaaS) and/or Software-as-a-Service (SaaS) offerings owned and managed by one or more different entities as is known in the art.

Monolithic application 110 may comprise executable program code as is known in the art. For example, monolithic application 110 may comprise a single executable file generated by compiling and/or interpreting program code of a high-level programming language. Monolithic application 110 may provide any suitable functionalities to one or more users 120. According to one non-exhaustive example, monolithic application 110 comprises an enterprise resource planning application providing functionalities which may include but are not limited to finance and accounting, supply chain, human resource, procurement, sales, and inventory management.

Monolithic application 110 executes within an application platform (not shown) providing a runtime environment therefor. The application platform may, for example, comprise a single computer server, a virtual machine, or a cluster of computer servers such as a Kubernetes cluster. Kubernetes is an open-source system for automating deployment, scaling and management of containerized applications. Each component of system 100 may therefore be implemented by one or more servers (real and/or virtual) or containers.

Monolithic application 110 provides functionality using data stored within database 130. Database 130 stores application metadata 132 which defines the entities of application 110. For example, application metadata 132 describes the structure and interrelationships (i.e., the schema) of logical entities upon which application 110 operates. Application data 134 comprises many database tables defined by the schema of application metadata 132. The database tables include data associated with particular instances of the logical entities. For example, a database table of application data 134 may be associated with a particular entity (e.g., Product). Each row of this database table is associated with a respective product and includes values for each attribute of the Product entity as defined by application metadata 132.

Database 130 may execute a database management system (not shown) as is known in the art. Database 130 comprise one or more storage systems, each of which may be standalone or distributed, on-premise or cloud-based. Database 130 may comprise any type of database, data warehouse, object store, or other storage system that is or becomes known.

Users 120 may access monolithic application 110 via a gateway (not shown) which routes requests from users 120 to application 110 and may also provide authentication, authorization, and load balancing. Monolithic application 110 operates to serve the incoming requests. Data describing the requests and actions taken in response thereto is stored in application logs 136 as is known in the art. Application logs 136 may specify queries received by database 130 from application 110, for example.

Table grouping component 140 may comprise a service and/or an application, and may be executed by the same application platform as monolithic application 110 or by a different application platform. Table grouping component 140 may communicate with database 130 (and/or with monolithic application 110) to acquire application logs 136. More specifically, table grouping component 140 may acquire queries received from monolithic application 110 during operation from application logs 136. Table grouping component 140 may use the acquired queries to determine table groupings according to some embodiments.

Based on the table groupings, the code of monolithic application 110 may be migrated into several microservices, where each microservice stores and manages the tables of one of the groupings. Each microservice may therefore include tables having close relationships with one another and cross-microservice calls during operation of the microservices may be minimized.

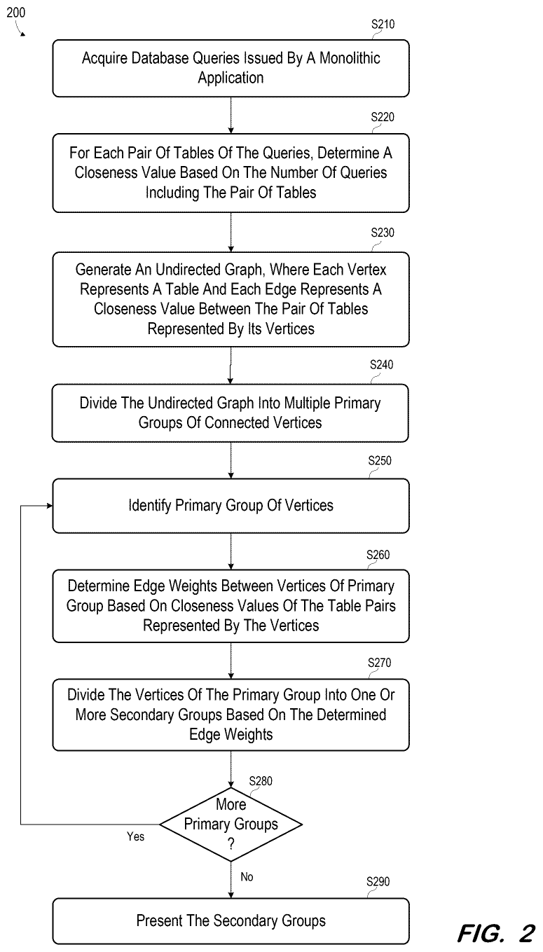

FIG. 2 is a flow diagram of process 200 to determine table groupings of a monolithic application according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, database queries issued by a monolithic application are acquired. The acquired database queries may consist of all database queries issued by the monolithic application during productive operation over a representative period of time, such as a time period spanning weekdays, weekends, working and non-working hours, and holiday and non-holiday seasons. In general, the acquired queries are intended to provide a representative distribution of queries issued by the monolithic application in response to user requests during productive operation.

The queries may comprise Structured Query Language (SQL) statements. The statements may be acquired from SQL statement execution logs maintained by the database which is queried by the monolithic application. In some embodiments of S210, the queries are intercepted before reception by the database and then passed on to the database for execution.

The acquired queries select from database tables associated with the monolithic application. Based on the queries, a closeness value is determined for each pair of the database tables at S220. The closeness value for a particular pair of tables is determined based on the number of queries which include the pair of tables.

For example, it is assumed that the following two queries are acquired at S210:

```
SELECT t1.*, t2.*, t3.* FROM T1 t1
  JOIN T2 t2 ON t1.COL1 = t2.COL2
  JOIN T3 t3 ON t1.COL1 = t3.COL3
and
SELECT t4.*, t5.*, t6.* FROM T4 t4, T5 t5, T6 t6
    WHERE t4.COL1 = t5.COL2 AND t4.COL1 = t6.COL3
```

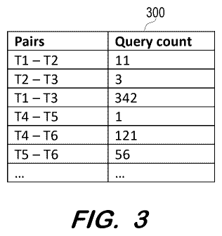

Based on the first query, query counts associated with each of table pairs T1-T2, T1-T3, and T2-T3 are incremented by 1. Similarly, the second query causes query counts associated with each of table pairs T4-T5, T4-T6, and T5-T6 to be incremented by 1. Generally, every query statement in the application log is assigned a value of “1” so every pair of tables used in a query statement will have its count or closeness value incremented by the value of “1”. FIG. 3 illustrates table 300 of query counts determined at S220 for various pairs of tables based on acquired queries. According to the present example, the query counts are the determined closeness values, but the closeness values may comprise any values otherwise derived from the query counts.

An undirected graph is generated at S230, where each vertex of the graph represents a table and each edge represents a closeness value c between the pair of tables represented by its vertices. The undirected graph includes an edge between vertices representing tables Tᵢ and Tⱼ only if c_{i,j}>Th, where Th may equal 0 or another low threshold value (to ignore rare queries which happen to associate two tables which are not otherwise associated).

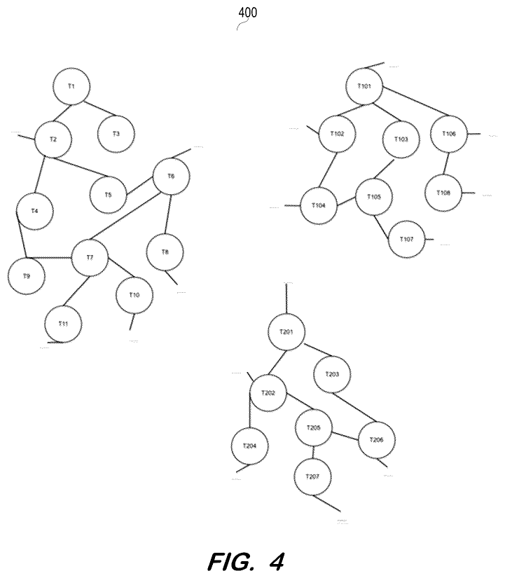

FIG. 4 is an example of undirected graph 400 of tables generated at S230 according to some embodiments. It should be noted that FIG. 4 is just an example of an undirected graph. FIG. 4 is shown as three, separate undirected graphs. From the above example, an application log could have two types of queries where one type only references tables T1, T2 and T3 and the other type only references tables T4, T5 and T6. As the queries of this example only reference one set of tables (the set consisting of T1, T2, T3 or the set consisting of T4, T5, T6), two separate undirected graphs would be generated at S230. FIG. 3 is also representative of this scenario in that there are no pairs shown between the set consisting of T1, T2 and T3 and the set consisting of T4, T5 and T6. However, if there were additional queries across these sets of tables (e.g., a query that included tables T2 and T5) with sufficient frequency in the application log, the resultant undirected graph would consist of a single graph of interconnected nodes. The half edges (e.g., those edges connected to one node only in FIG. 4) are representative of either larger undirected graphs (e.g., graphs with more than eleven nodes) or eventual connections through intervening nodes and edges to other graphs (i.e., the three separate undirected graphs could, in other scenarios, be connected together to make one or two undirected graphs).

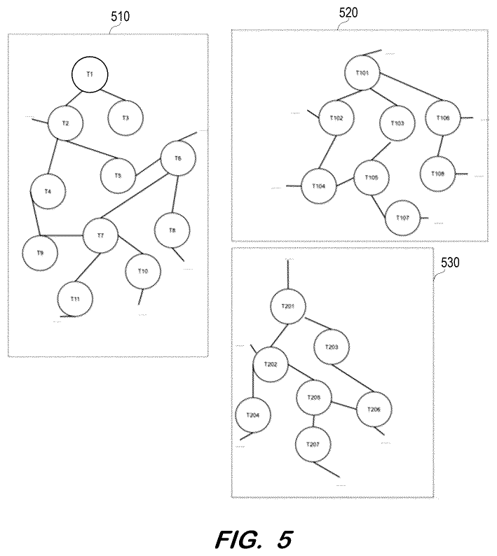

Next, at S240, the undirected graph (or graphs) is divided into multiple primary groups of connected vertices. In some embodiments of S240, the undirected graph is searched by a depth-first or breadth-first search algorithm to identify vertices which are linked to one another directly or via one or more intermediate navigation relationships. FIG. 5 shows three primary groups 510, 520 and 530 of tables generated from undirected graph 400 at S240 according to some embodiments.

It is expected that the number of tables of at least one primary group will be too large to be included within one microservice. Accordingly, S250-S280 are executed to generate secondary groups of one or more of the primary groups. For example, one of the primary groups of entities is identified at S250. Next, edge weights between vertices of primary group are determined based on closeness values of the table pairs represented by the vertices.

The edge weights e_{i,j} may be represented by matrix E

$$E = [ \begin{matrix}0 & {e}_{1 , 2} & {e}_{1 , 3} & ⋯ & {e}_{1 , M} \\ {e}_{1 , 2} & 0 & {e}_{2 , 3} & ⋯ & \\ {e}_{1 , 3} & {e}_{2 , 3} & 0 & ⋯ & ⋮ \\ ⋮ & ⋮ & ⋮ & ⋱ & \\ {e}_{1 , M} & & ⋯ & & 0\end{matrix} ] ,$$

where e_{i,j} is calculated by

$${e}_{i , j} = \{ \begin{matrix}\frac{{c}_{max}}{{c}_{i , j}} , & if {c}_{i , j} \neq 0 \\ 0 , & if {c}_{i , j} = 0\end{matrix} ,$$

and cₘₐₓ is the maximum closeness value determined at S220.

The vertices of the primary group are divided into one or more secondary groups based on the determined edge weights at S270. Next, at S280, it is determined whether additional primary groups exist. If so, flow returns to S250 to identify another primary group. Flow proceeds as described above to divide the vertices of the primary groups into secondary groups until no primary groups remain to be divided.

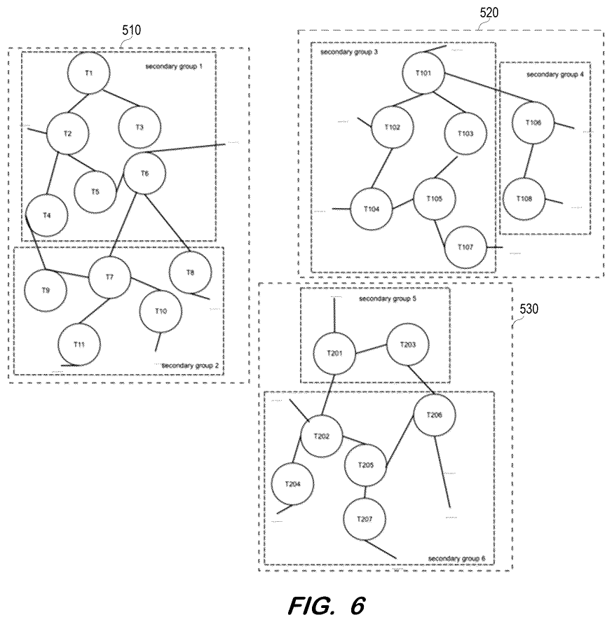

FIG. 6 shows primary group 510 split into secondary groups 1 and 2, primary group 520 split into secondary groups 3 and 4, and primary group 530 split into secondary groups 5 and 6. All of the determined secondary groups are presented at S290. If no secondary groups are determined for a primary group, that primary group may also be presented at S290. Embodiments may also indicate the primary groups from which each secondary group was formed. The groups of tables may be used to refactor the monolithic application into microservices as described above.

The following is an example of process 200 according to some embodiments. Embodiments are not limited to the example. Initially, it is assumed that the queries acquired at S210 include six tables T0, T1, T2, T3, T4, T5 and T6. The closeness value c determined for each pair of tables Tᵢ and Tⱼ at S220 are as shown below in closeness matrix C, where c_{i,j}=c_{j,i}.

$$C = [ \begin{matrix}0 & 60000 & 1500 & 3500 & 7600 & 7800 \\ 60000 & 0 & 0 & 4000 & 8400 & 0 \\ 1500 & 0 & 0 & 56000 & 0 & 5800 \\ 3500 & 4000 & 56000 & 0 & 8300 & 13000 \\ 7600 & 8400 & 0 & 8300 & 0 & 45000 \\ 7800 & 0 & 5800 & 13000 & 45000 & 0\end{matrix} ]$$

FIG. 7 illustrates corresponding undirected graph 700 generated at S230 based on matrix C. Since all vertices of graph 700 are connected to one another directly or through intermediate vertices, undirected graph 700 includes one primary group. It is assumed that the primary group is to be divided into K=3 groups of tables.

Edge matrix E is determined from closeness matrix C at S260, where

$${e}_{i , j} = \{ \begin{matrix}\frac{{c}_{max}}{{c}_{i , j}} , & if {c}_{i , j} \neq 0 \\ 0 , & if {c}_{i , j} = 0\end{matrix}$$

$$E = [ \begin{matrix}0 & 1 & 40 & 17.1 & 7.9 & 7.7 \\ 1 & 0 & 0 & 15 & 7.1 & 0 \\ 40 & 0 & 0 & 1.1 & 0 & 10.3 \\ 17.1 & 15 & 1.1 & 0 & 7.2 & 4.6 \\ 7.9 & 7.1 & 0 & 7.2 & 0 & 1.3 \\ 7.7 & 0 & 10.3 & 4.6 & 1.3 & 0\end{matrix} ]$$

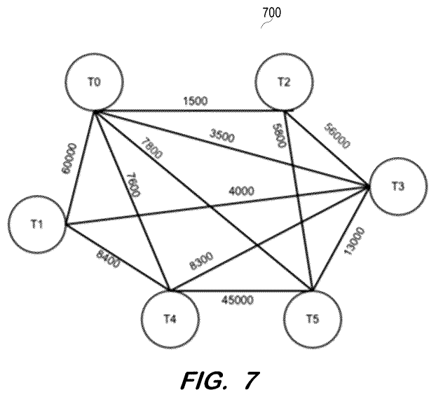

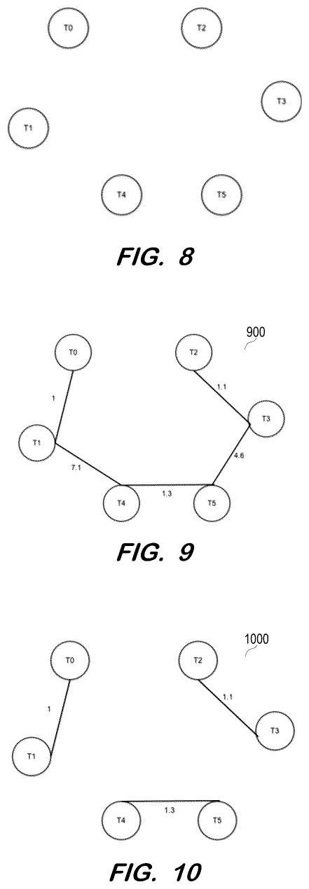

Division of the vertices of graph 700 into one or more secondary groups at S270 may then proceed as follows. First, all e_{i,j} for the elements with e_{i,j}>0 and i<j are determined and used to populate a vector in non-decreasing order=[e_{0,1}, e_{2,3}, e_{4,5}, e_{3,5}, e_{1,4}, e_{2,4}, e_{0,5}, e_{0,4}, e_{1,3}, e_{0,3}, e_{0,2}]=[1, 1.1, 1.3, 4.6, 7.1, 7.2, 7.7, 7.9, 15, 17.1, 40]. Next, an undirected weighted graph with six vertices and no edges is constructed as shown in FIG. 8.

Starting from the beginning of the sorted vector, pairs of vertices i and j are joined by a weighted edge until all vertices are connected to an edge. Edges which result in a cyclical graph are discarded. Referring to FIG. 9 and the vectors shown above, vertices T0 and T1 are joined by an edge having a weight of e_{0,1}=1. Vertices T2 and T3 are joined by an edge having a weight of e_{2,3}=1.1, vertices T4 and T5 are joined by an edge having a weight of e_{4,5}=1.3, vertices T3 and T5 are joined by an edge having a weight of e_{3,5}=4.6, and vertices T1 and T4 are joined by an edge having a weight of e_{1,4}=7.1. No edge having a weight e_{2,4}=7.2 joins vertices T2 and T4 because such an edge would create a cyclical path including T2, T3, T5, T4 and T2, and because each vertex of graph 900 is connected to an edge. Graph 900 is referred to as a minimum spanning tree.

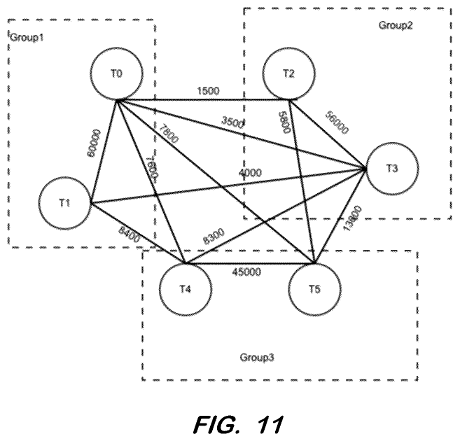

The longest K−1 edges are then removed from the minimum spanning tree. FIG. 10 shows disconnected trees 1000 resulting from removing the two highest-weighted edges of graph 900. Each disconnected tree represents a respective secondary group of tables. FIG. 11 illustrates groups Group 1, Group 2 and Group 3 determined at S270 based on disconnected trees 1000.

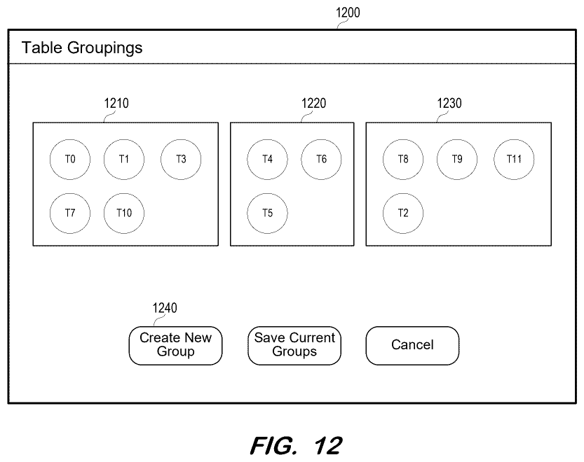

FIG. 12 is a view of interface 1200 to present groupings of tables of a monolithic application at S290 according to some embodiments. In one non-exhaustive example, user 150 operates a device (e.g., a desktop computer) to launch a Web browser application. The administrator inputs a Uniform Resource Locator (URL) associated with table grouping application 140, causing the Web browser to send a request to a cloud gateway corresponding to the URL. The gateway may perform authentication/authorization and forward the request to table grouping application 140, in response to which table grouping application 140 returns a Web page including interface 1200 to the Web browser for display thereby.

Interface 1200 shows table groups 1210, 1220 and 1230. Interface 1200 may allow the administrator to drag and drop tables from one group to another group. In this regard, Create New Group control 1240 may be selected to create a new group into which one or more of the presented tables may be dragged and dropped. In addition, a user may indicate that two tables must be in the same grouping, for example by dragging one table icon to overlap another table icon. As a result, the computer system may assign an infinite or other query count value to the pair consisting of these two tables so that the tables will be assigned to the same group even if process 200 is re-executed to re-group the tables. As described above, a respective microservice may be developed for each of groupings 1210, 1220 and 1230, where the microservice developed for a grouping stores and operates on each table of the grouping.

It should be noted that interface 1200 can be called and displayed at any time. For example, the monolithic application could be refactored into microservices and the associated database tables reapportioned automatically following embodiments described herein. However, after such computer system realignments, interface 1200 could be called to assist a user in adjusting the table groupings. In addition, interface 1200 could be called before any computer system realignment so a user may adjust the groupings before deployment.

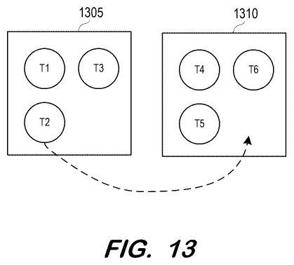

FIG. 13 represents computer system 1300 according to some embodiments. Computer system 1300 includes microservice 1305 and microservice 1310. Database tables T1, T2 and T3 have been apportioned to microservice 1305 and database tables T4, T5 and T6 have been apportioned to microservice 1310. Embodiments may operate to determine whether reapportioning any of database tables T1 to T6 will improve overall computing efficiency. For example, if microservice 1310 has been modified over time such that its queries to database table T2 have increased, embodiments may determine to move or transfer database table T2 from microservice 1305 to microservice 1310 to thereby reduce cross-microservice traffic without overburdening microservice 1310 with database tables.

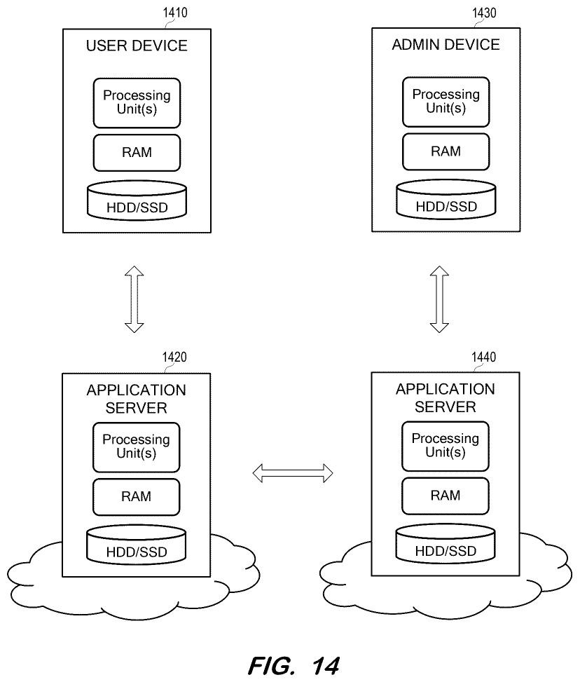

FIG. 14 illustrates a cloud-based database deployment according to some embodiments. User device 1410 may comprise a local computing system operated by a user to access functionality of a monolithic application executed by application server 1420. Administrator device 1430 may comprise a local computing system operated by an administrator to access a table grouping application executed by application server 1440. The table grouping application may determine groupings of tables of the monolithic application based on logs stored in application server 1420 as described above.

Either of application servers 1420 and 1440 may comprise cloud-based resources residing in one or more public clouds providing self-service and immediate provisioning, autoscaling, security, compliance and identity management features. Servers 1420 and 1440 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A first computer system for realigning a second computer system, the first computer system comprising:
a memory storing program code; and
at least one processing unit to execute the program code to cause the first computer system to:
identify a plurality of tables of the second computer system;
determine, based on queries issued by the second computer system, a value associated with each pair of tables of the plurality of tables;
determine a plurality of primary groups of the plurality of tables based on the values, where no pairs of tables belonging to different primary groups are associated with values greater than a first threshold value;
for each of the plurality of primary groups:
determine edge weights between each table of the primary group based on the determined values; and
divide the tables of the primary group into one or more secondary groups of tables based on the determined edge weights; and
realignment of the second computer system based on the secondary groups of tables.

2. The first computer system of claim 1, wherein realignment of the second computer system comprises:
refactoring a monolithic application into microservices, wherein each of the microservices stores a respective secondary group of tables.

3. The first computer system of claim 2, wherein the value for each pair of tables of the plurality of tables is based on a number of the queries issued by the monolithic application which select from both tables of the pair of tables.

4. The first computer system of claim 2, the at least one processing unit to execute the program code to cause the first computer system to:
present the secondary groups of tables; and
receive instructions to modify the secondary groups of tables,
wherein refactoring of the monolithic application into microservices comprises refactoring of the monolithic application into microservices based on the modified secondary groups of tables.

5. The first computer system of claim 2, wherein dividing of the tables of a primary group into one or more secondary groups of tables based on the determined edge weights comprises:
forming a minimum spanning tree of the tables based on the determined edge weights; and
removing edges of the minimum spanning tree associated with the largest determined edge weights.

6. The first computer system of claim 5, wherein each of the microservices stores a respective secondary group of tables.

7. The first computer system of claim 6, wherein the value for each pair of tables of the plurality of tables is based on a number of the queries issued by the monolithic application which select from both tables of the pair of tables.

8. The first system of claim 1, wherein the second computer system comprises a plurality of microservices and realignment of the second computer system comprises transferring one table from a first microservice of the plurality of microservices to a second microservice of the plurality of microservices.

9. The first computer system of claim 8, wherein dividing of the tables of a primary group into one or more secondary groups of tables based on the determined edge weights comprises:
forming a minimum spanning tree of the tables based on the determined edge weights; and
removing edges of the minimum spanning tree associated with the largest determined edge weights.

10. The first computer system of claim 8, wherein each of the plurality of microservices stores a respective secondary group of tables.

11. A method for realigning a computer system, the method comprising:
determining, based on queries issued by the computer system, a value associated with each pair of tables of a plurality of tables;
determining a plurality of groups of the plurality of tables based on the values, where no pairs of tables belonging to different primary groups are associated with values greater than a first threshold value;
for each of the plurality of groups:
determining edge weights between each table of the group based on the determined values; and
dividing the tables of the group into one or more secondary groups of tables based on the determined edge weights; and
realigning the computer system based on the secondary groups of tables.

12. The method of claim 11, wherein realigning the computer system comprises refactoring the monolithic application into microservices, wherein each of the microservices stores a respective secondary group of tables.

13. The method of claim 12, wherein the value for each pair of tables of the plurality of tables is based on a number of the queries issued by the monolithic application which select from both tables of the pair of tables.

14. The method according to claim 12, further comprising:
presenting the secondary groups of tables; and
receiving instructions to modify the secondary groups of tables,
wherein refactoring the monolithic application into microservices comprises refactoring the monolithic application into microservices based on the modified secondary groups of tables.

15. The method of claim 11, wherein the computer system comprises a plurality of microservices and realignment of the computer system comprises transferring one table from a first microservice of the plurality of microservices to a second microservice of the plurality of microservices.

16. The method of claim 15, wherein each of the plurality of microservices stores a respective secondary group of tables.

17. One or more non-transitory computer-readable media storing program code, the program code executable to cause a first computer system to realign a second computer system by:
identifying a plurality of tables of the second computer system;
determining, based on queries issued by the second computer system, a value associated with each pair of tables of the plurality of tables;
determining a plurality of primary groups of the plurality of tables based on the values, where no pairs of tables belonging to different primary groups are associated with values greater than a first threshold value;
for each of the plurality of primary groups:
determining edge weights between each table of the primary group based on the determined values; and
dividing the tables of the primary group into one or more secondary groups of tables based on the determined edge weights; and
realigning the second computer system based on the secondary groups of tables.

18. The one or more non-transitory computer-readable media of claim 17, wherein the realignment of the second computer system comprises refactoring a monolithic application into microservices, wherein each of the microservices stores a respective secondary group of tables.

19. The one or more non-transitory computer-readable media of claim 18, wherein the value for each pair of tables of the plurality of tables is based on a number of the queries issued by the monolithic application which select from both tables of the pair of tables.

20. The one or more non-transitory computer-readable media of claim 17, wherein the second computer system comprises a plurality of microservices and realignment of the second computer system comprises transferring one table from a first microservice of the plurality of microservices to a second microservice of the plurality of microservices, and
wherein each of the plurality of microservices stores a respective secondary group of tables.
